(19) United States
(12) Patent Application Publication
(10) Pub. No.: US 2017/0371693 A1
(43) Pub. Date: Dec. 28, 2017

(54) MANAGING CONTAINERS AND CONTAINER HOSTS IN A VIRTUALIZED COMPUTER SYSTEM

(71) Applicant: VMware, Inc., Palo Alto, CA (US)

(72) Inventors: Benjamin J. CORRIE, San Francisco, CA (US); George HICKEN, San Francisco, CA (US); Aaron SWEEMER, Cincinnati, OH (US); Zee YANG, Santa Clara, CA (US)

(21) Appl. No.: 15/190,628

(22) Filed: Jun. 23, 2016

(51) Int. Cl. G06F 9/455; G06F 17/30

(52) U.S. Cl. CPC G06F 9/45558; G06F 17/30233; G06F 2009/4557; G06F 2009/45595; G06F 2009/45575

(57) ABSTRACT

One example relates to a computer system that includes a plurality of host computers each executing a hypervisor. The computer system further includes a virtualization manager having an application programming interface (API) configured to manage the hypervisor on each of the plurality of host computers, the virtualization manager configured to create a virtual container host within a resource pool that spans the plurality of host computers. The computer system further includes a plurality of container virtual machines (VMs) in the virtual container host configured to consume resources in the resource pool. The computer system further includes a daemon appliance executing in the virtual container host configured to invoke the API of the virtualization manager to manage the plurality of container VMs in response to commands from one or more clients.

### BACKGROUND

Computer virtualization is a technique that involves encapsulating a physical computing machine platform into virtual machine(s) executing under control of virtualization software on a hardware computing platform or “host.” A virtual machine provides virtual hardware abstractions for processor, memory, storage, and the like to a guest operating system. The virtualization software, also referred to as a “hypervisor,” includes one or more virtual machine monitors (VMMs) to provide execution environment(s) for the virtual machine(s). As physical hosts have grown larger, with greater processor core counts and terabyte memory sizes, virtualization has become key to the economic utilization of available hardware.

Virtual machines provide for hardware-level virtualization. Another virtualization technique is operating system-level (OS-level) virtualization, where an abstraction layer is provided on top of a kernel of an operating system executing on a host computer. Such an abstraction is referred to herein as a “container.” A container executes as an isolated process in user-space on the host operating system (referred to as the “container host”) and shares the kernel with other containers. A container relies on the kernel's functionality to make use of resource isolation (processor, memory, input/output, network, etc.). Containers and VMs are generally referred to herein as “virtualized computing instances.”

A container host can execute directly on a host computer or within a VM. However, a container host executing in a VM can be problematic from a management perspective. The operating system of the container host does not provide adequate multi-tenant namespace support in an enterprise context. Also, each container host executing in a VM is a silo that explicitly reserves resources (processor and memory) for the exclusive use of the containers therein. As such, no other VM on the host system can make use of memory or compute resources that are freed when the containers in the container host are stopped. There is a need for more efficient implementation and management of containers and container hosts in a virtualized computing system.

### SUMMARY

One embodiment relates to a computer system that includes a plurality of host computers each executing a hypervisor. The computer system further includes a virtualization manager having an application programming interface (API) configured to manage the hypervisor on each of the plurality of host computers, the virtualization manager configured to create a virtual container host within a resource pool that spans the plurality of host computers. The computer system further includes a plurality of container virtual machines (VMs) in the virtual container host configured to consume resources in the resource pool. The computer system further includes a daemon appliance executing in the virtual container host configured to invoke the API of the virtualization manager to manage the plurality of container VMs in response to commands from one or more clients.

In another embodiment, a computer system includes a hardware platform and a hypervisor executing on the hardware platform, the hypervisor including an application programming interface (API). The computer system further includes a plurality of container VMs supported by the hypervisor and a daemon appliance configured to invoke the API of the hypervisor to manage the plurality of container VMs in response to commands from one or more clients.

In another embodiment, a method of managing container virtual machines (VMs) in a virtualized computing system includes creating a virtual container host within a resource pool that spans a plurality of host computers, the plurality of host computers each executing a hypervisor managed through an application programming interface (API) of a virtualization manager. The method further includes creating a daemon appliance executing in the virtual container host configured to invoke the API of the virtualization manager. The method further includes creating a plurality of container VMs in the virtual container host configured to consume resources in the resource pool in response to commands from one or more clients received at the daemon appliance. In another embodiment, a computer readable medium comprising instructions executable by a computer system to perform the above-described method is provided.

### BRIEF DESCRIPTION OF THE DRAWINGS

FIG. 1 is a block diagram depicting a computing system according to an embodiment.

FIG. 2 is a block diagram depicting an embodiment of a virtualized computing system.

FIG. 3 is a block diagram depicting another embodiment of a virtualized computing system.

FIG. 4 is a flow diagram illustrating a virtual container host lifecycle according to an embodiment.

FIG. 5 is a flow diagram illustrating a lifecycle of a container virtual machine (VM) according to an embodiment.

FIG. 6 is a flow diagram illustrating a lifecycle of a container VM according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

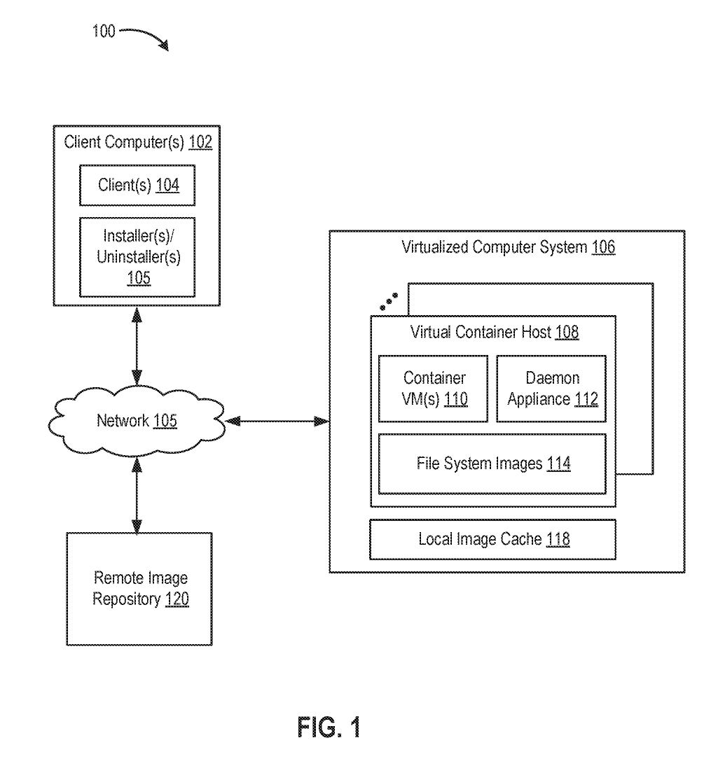

FIG. 1 is a block diagram depicting a computing system 100 according to an embodiment. Computing system 100 includes one or more client computers (“client computer(s) 102”, network 105, virtualized computer system 106, and remote image repository 120. Client computer(s) 102 execute one or more client applications (“client(s) 104”). Client computer(s) 102 communicate with virtualized computer system 106 through network 105. Remote image repository 120 stores filesystem images for use by virtualized computer system 106, as described below.

Virtualized computer system 106 supports one or more virtual container hosts 108. Each virtual container host 108 includes a daemon appliance 112, one or more container virtual machines (“container VM(s) 110”), and file system images 114. Virtualized computer system 106 also includes a local image cache 118. Virtualized computer system 106 communicates with remote image repository 120 through network 120. Local image cache 118 caches filesystem images obtained from remote image repository 120. Virtual container host(s) 108 can be managed (e.g., provisioned, started, stopped, removed) using installer(s)/uninstaller(s) 105 executing on client computer(s) 102.

Virtualized computer system 106 provides virtualization software executing on top of one or more host computer systems. Embodiments of virtualized computer system 106 are described below. In an embodiment, the virtualization software comprises one or more hypervisors each of which allows multiple virtual machines to share the hardware resources of a host computer system (“hardware-level virtualization”). A hypervisor provides benefits of resource isolation and allocation of hardware resources among the virtual machines. Another type of virtualization layer is a container host that allows multiple containers to share resources of an operating system (OS) (“operating system-level virtualization”). A conventional container runs as an isolated process in user-space on the OS and shares the kernel of the OS with other containers. A conventional container relies on the kernel's functionality to make use of resource isolation (processor, memory, network, etc.) and separate namespaces to isolate the container's processes. A container host can be executed in a virtual machine, where the containers and a management daemon execute inside the virtual machine.

As discussed above, however, there are deficiencies associated with executing a container host in a virtual machine. Virtual container host(s) 108 overcome those deficiencies. A virtual container host 108 is not a virtual machine, but rather an abstraction of a container host supported by a dynamically-configurable pool of resources of virtualized computer system 106. In a virtual container host 108, a container executes as a virtual machine (referred to herein as a “container VM”), rather than in a virtual machine. The container VMs are provisioned into the resource pool that defines the virtual container host 108. The resources designated for a virtual container host can be all or a portion of a host computer, or all or a portion of a cluster of host computers. The container VM relies on hypervisor functionality for resource and process isolation. In an embodiment, the container VM is a virtual machine that functions as a single container. The VM provides the resource constraints and a private namespace, similar to a container. In embodiments, a container VM is provisioned by attaching a file system image to the container VM as a disk, either booting the container VM from a kernel image or forking the container VM from a parent VM, and then changing the apparent root directory to that of the container file system (e.g., chroot).

Daemon appliance 112 provides an interface to virtualized computer system 106 for the creation of container VM(s) 110. Daemon appliance 112 provides an application programming interface (API) endpoint for virtual container host 108. In an embodiment, daemon appliance 112 executes as a virtual machine in virtualized computer system 106. In another embodiment, daemon appliance 112 is a service executed by the virtualization software (e.g., executed by a hypervisor). Client(s) 104 communicate with daemon appliance 112 to build, run, stop, update, and delete containers implemented by container VM(s) 110. In an embodiment, each daemon appliance 112 can be managed by a particular tenant, which enables multi-tenancy for virtualized container hosts 108. Alternatively, one daemon appliance 112 can support multiple tenants by managing multiple virtualized container hosts 108. The fact that the containers are implemented as virtual machines is transparent to the client(s) 104. Client(s) 104 can be any type of existing client for managing conventional containers, such as a Docker client (www.docker.com). Daemon appliance 112 interfaces with virtualized computer system 106 to provision, start, stop, update, and delete container VMs 110. Daemon appliance 112 can also interface with container VM(s) 110 to control operations performed therein, such as launching processes, streaming standard output/standard error, setting environment variables, and the like.

A container VM 110 includes binaries, configuration settings, and resource constraints (e.g., assigned processor, memory, and network resources). Daemon appliance 112 can build container VM(s) 110 from file system images 114. File system images 114 can include a tree of file system slices designed to be layered on top of other slices to create a coherent file system for a given container VM 110. Each file system image 114 can include binaries, configuration files, and the like. File system images 114 can be obtained from remote image repository 120 and stored in local image cache 118. In an embodiment, file system images 114 are attached to container VM(s) 110 using virtual disks. Daemon appliance 112 can obtain additional images from remote image repository 120 through network 105. Each daemon appliance 112 can also upload images from local image cache 118 to remote image repository 120 through network 105.

Virtualized computer system 106 provides an execution engine for a container ecosystem. A virtual container host provides a compatible and transparent container experience without using traditional containers (e.g., Linux® containers). Instead, containers are provisioned directly to a hypervisor as virtual machines using a 1:1 VM-to-container model. The container VM does not itself contain any software virtualization or container engine daemon (e.g., Docker from www.docker.com). Rather, the hypervisor provides the necessary runtime isolation between container VMs. The virtual container host brings the robustness, isolation, and configurability of the VM abstraction to each container, while ensuring optimal resource sharing with other non-container workloads. The benefits of this approach when compared with creating containers inside VMs include: 1) simplified management, configuration, and capacity planning without the need for an explicit container host; 2) a container VM consumes the resources it needs while running and gives those resources back to the data center when stopped; 3) processor scheduling is more efficient without a nested scheduler in a container host; and 4) virtual container host provides for more granular management and monitoring of the container VMs. With respect to capacity and planning, a virtual container host is dynamically configurable (e.g., memory and CPU limits can be dynamically adjusted) with no impact on the container VMs. In contrast, a container host that executes in a VM has to be restarted in order to be reconfigured, requiring the containers to be shut down. Further, a container host executing in a VM is an example of nested virtualization. Nested virtualization requires infrastructure configuration and maintenance at two levels (e.g., configuration and maintenance of network and storage virtualization at two levels). The virtual container host collapses that stack, providing for a single level of virtualization. Further, the container VMs can potentially support any x86-compatible operating system, whereas conventional containers are supported only within the scope of a single operating system.

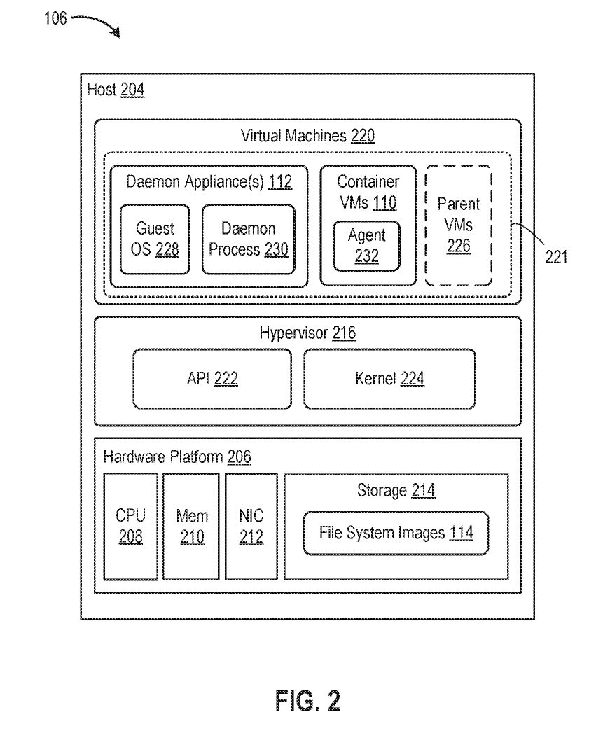

FIG. 2 is a block diagram depicting an embodiment of virtualized computing system 106. Virtualized computing system 106 includes a host computer (“host 204”). Host 204 includes a hardware platform 206. As shown, hardware platform 206 includes conventional components of a computing device, such as one or more processors (CPUs) 208, system memory 210, a network interface 212, storage system 214, and other I/O devices such as, for example, a mouse and keyboard (not shown). CPU 208 is configured to execute instructions, for example, executable instructions that perform one or more operations described herein and may be stored in memory 210 and in local storage. Memory 210 is a device allowing information, such as executable instructions and data to be stored and retrieved. Memory 210 may include, for example, one or more random access memory (RAM) modules. Network interface 212 enables host 204 to communicate with another device via a communication medium. Network interface 212 may be one or more network adapters, also referred to as a Network Interface Card (NIC). Storage system 214 represents local storage devices (e.g., one or more hard disks, flash memory modules, solid state disks, and optical disks) and/or a storage interface that enables host 204 to communicate with one or more network data storage systems. Examples of a storage interface are a host bus adapter (HBA) that couples host 204 to one or more storage arrays, such as a SAN or a NAS, as well as other network data storage systems.

Host 204 is configured to provide a virtualization layer that abstracts processor, memory, storage, and networking resources of hardware platform 206 into multiple virtual machines (VMs) 220 that run concurrently on the same hosts. VMs 220 run on top of a software interface layer, referred to herein as a hypervisor 216, which enables sharing of the hardware resources of host 204 by VMs 220. One example of hypervisor 216 that may be configured and used in embodiments described herein is a VMware ESXi™ hypervisor provided as part of the VMware vSphere® solution made commercially available from VMware, Inc. of Palo Alto, Calif. (although it should be recognized that any other virtualization technologies, including Xen® and Microsoft Hyper-V® virtualization technologies may be utilized consistent with the teachings herein). Hypervisor 216 may run on top of an operating system of host 204 or directly on hardware components of host 204.

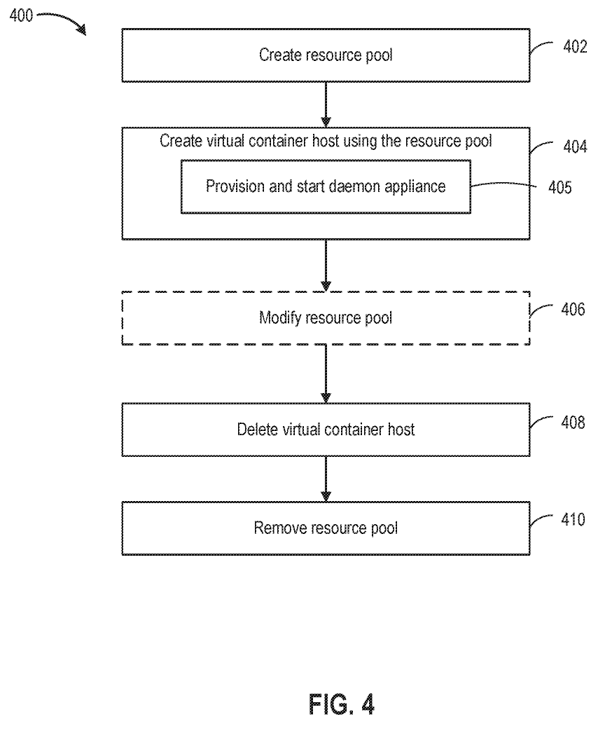

Hypervisor 216 includes an API 222 and a kernel 224. In general, clients can use API 222 to manage VMs 220 and hypervisor 216, such as creating and removing resource pools, provisioning, starting, stopping, and deleting VMs, etc. In an embodiment, a user interacts with hypervisor 216 through API 222 using a virtualization manager or other client software to create resource pool(s) 221. Installer(s) 105 use API 222 to provision daemon appliance(s) 112 within resource pool(s) 221, which provide endpoint(s) for virtual container host(s). Uninstaller(s) 105 use API 222 to de-provision daemon appliance(s) 112, which de-provisions virtual container host(s). Lifecycle management of a virtual container host is described further below with respect to FIG. 4. Kernel 224 provides the underlying OS of hypervisor 216 that controls hardware platform 206, manages processes of hypervisor 216 (e.g., API 222), and manages VMs 220.

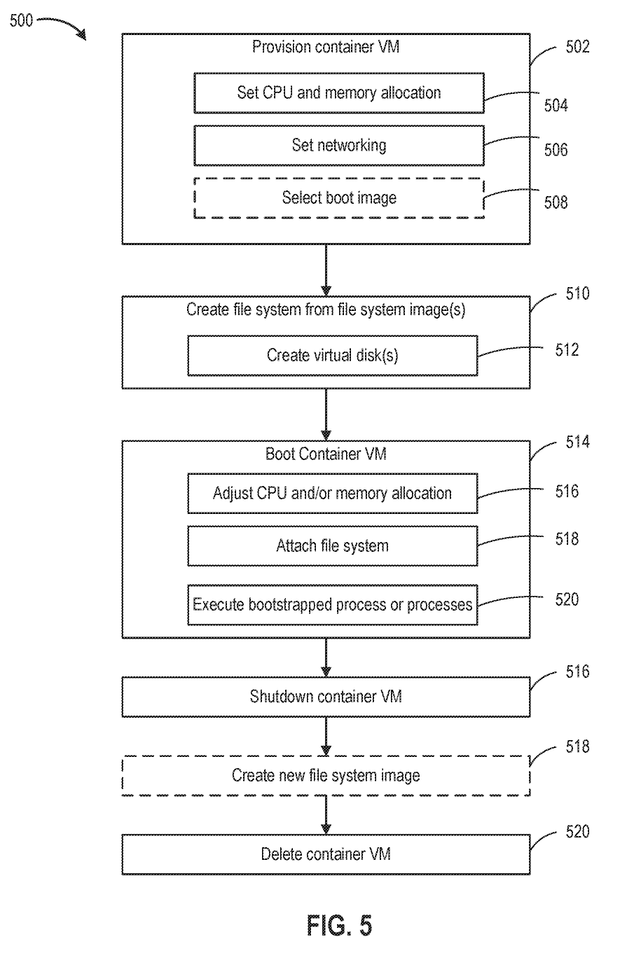

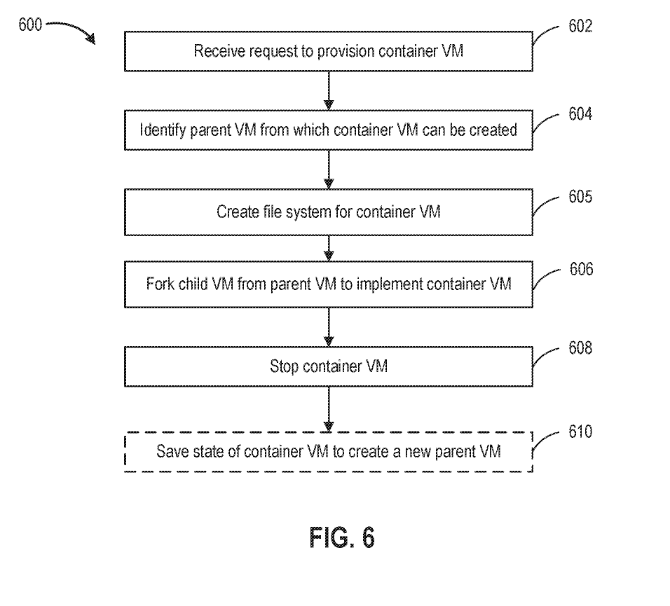

In an embodiment, daemon appliance 112 includes a guest operating system (“guest OS 228”) and a daemon process 230 executing within the guest OS 228. Clients interact with daemon process 230 to manage container VMs 110, such as creating, starting, stopping, updating, and deleting container VMs 110. Container VMs 110 consume resources of the particular resource pool 221 assigned to their virtual container host. Daemon process 230 interfaces with hypervisor 216 either directly with kernel 224 or through API 222 to manage virtual machines 220 implementing container VMs 110, such as provisioning, starting, stopping, deleting virtual machines 220 implementing container VMs 110. Daemon process 230 is configured to manage the lifecycle of container VMs 110 within a virtual container host. Lifecycle management of a container VM is described further below with respect to FIGS. 5-6. In an embodiment, daemon process 230 can control operations performed within each container VM 110 through interaction with an agent 232. Agent 232 provides a control path between daemon appliance 112 and a container VM 110 for performance various operations, such as launching processes, setting environment variables, configuring network resources, etc.

In other embodiments, daemon process 230 can execute within hypervisor 216, rather than within a VM. That is, daemon process 230 of each daemon appliance 112 can execute on kernel 224, rather than within a guest OS of a VM. In such an embodiment, daemon process 230 operates as described above.

In an embodiment, storage 214 can store file system images 114 for use by daemon process 230 when creating container VMs 110. In another embodiment, daemon process 230 can access file system images in remote storage (not shown) through NIC 212.

In an embodiment, some of container VMs 110 are created and started by provisioning a virtual machine, booting the virtual machine, attaching the file system (e.g., attaching virtual disks), and optionally adding additional memory and/or processor capacity. In other embodiments, some of container VMs 110 are created and started by forking from a parent VM 226, as described further below.

In some embodiments, hypervisor 216 is capable of cloning or forking one VM from another. During the forking process, the parent VM is suspended and its memory state becomes an immutable read-only memory (ROM) image from which the child VM continues to execute. The child VM only consumes the memory delta from the parent VM and can be provisioned in less time than booting a VM from scratch. For example, the ESXi™ hypervisor includes a feature known as VMFork that implements such a technique. Such a forking process can be used to create and start container VMs 110. In an embodiment, daemon process 230 can manage creation of parent VMs 226.

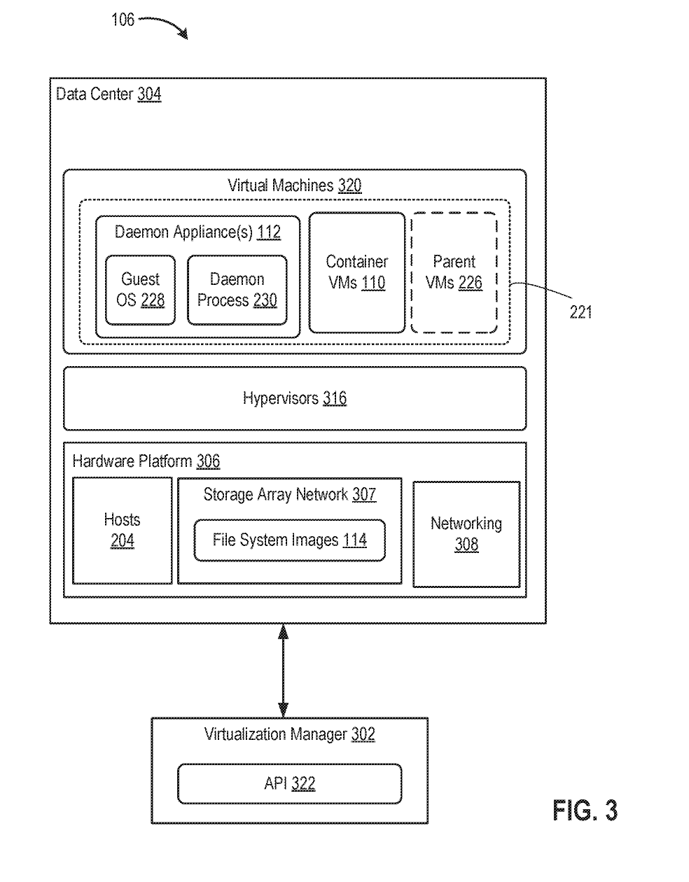

FIG. 3 is a block diagram depicting another embodiment of virtualized computing system 106. Elements of FIG. 3 that are the same or similar to those of FIGS. 1 and 2 are designated with identical reference numerals. In the present embodiment, virtualized computing system 106 includes a data center 304. Data center 304 includes a hardware platform 306 comprise a plurality of hosts 204, a storage array network (SAN) 307, and networking components (“networking 308”). Hardware platform 306 supports execution of hypervisors 316. Hypervisors 316 support execution of virtual machines 320. Data center 304 is coupled to a virtualization manager 302 configured to manage hosts 204, hypervisors 316, and virtual container hosts within data center 304. Virtualization manager 302 can be a computer having virtualization management software executing therein. Virtualization manager 302 includes an API 322. In the present embodiment, rather than or in addition to directly interfacing with an API in a hypervisor, client(s) 104 and installer(s)/uninstaller(s) 105 interface with API 322 in virtualization manager 302. In turn, virtualization manager 302 interfaces with APIs in hypervisors 316.

Users can interact with virtualization manager 302 to create resource pools 221 in data center 304. Each resource pool 221 can be a portion of a host, an entire host, or a portion or all of multiple hosts. Each resource pool 221 can include storage resources allocated from storage array network 307 and network resources allocated from networking 308. Each virtual container host is assigned a resource pool 221 and supports execution of virtual machines 320, which include daemon appliance(s) 112, container VMs 110, and optionally parent VMs 226. Storage array network 307 can store file system images 114.

FIG. 4 is a flow diagram illustrating a virtual container host lifecycle 400 according to an embodiment. Virtual container host lifecycle 400 can be controlled by software executing on a computer and interacting with a hypervisor API, virtualization manager API, or both (e.g., installers, client applications, etc.). At block 402, a user invokes the software to create a resource pool. For example, the user can create a resource pool in a single host 204 or within data center 304. The resource pool can span a portion of a host, all of one host, or a portion or all of multiple hosts. The resource pool can also include resources other than hosts, such as external storage resources (e.g., SAN 307) and external network resources (e.g., networking 308).

At block 404, a user invokes the software to create a virtual container host that uses the resource pool. In an embodiment, the software interacts with an API to initialize the virtual container host by provisioning and starting a daemon appliance 112 at block 405. As discussed above, the daemon appliance 112 can be a VM or a service executing directly on the hypervisor.

At optional block 406, the user invokes the software to modify the resource pool confining the virtual container host. That is, resources can be added to or removed from the resource pool. Thus, the resource pool of a virtual container host is dynamically configurable and can be modified without impacting the container VMs (e.g., the container VMs do not have to be shut down).

At block 408, the user can invoke the software to delete a virtual container host. During deletion, the software interacts with an API to stop and delete daemon appliance 112. At block 410, the user can invoke the software to remove the resource pool.

FIG. 5 is a flow diagram illustrating a lifecycle 500 of a container VM according to an embodiment. Container VM lifecycle 500 can be controlled by a daemon appliance 112. At block 502, daemon appliance 112 provisions a container VM 110. Daemon appliance 112 can provision a container VM 110 in response to a request to create a container received from a client application. Daemon appliance 112 can provision the container VM 110 using an API, such as API 222 of hypervisor 216 or API 322 of virtualization manager 302.

An embodiment of block 502 includes a block 504, where daemon appliance 112 sets CPU and memory allocation for the container VM. Daemon appliance 112 can use a specific CPU and memory allocation provided by the user, or can use a default CPU and memory allocation for the virtual container host. At block 506, daemon appliance 112 allocates networking resources to the container VM. At optional block 508, daemon appliance 112 can select a boot image for the container VM. Alternatively, a user can specify a boot image for the container VM.

At block 512, daemon appliance 112 creates a file system from file system image(s). In an embodiment, daemon appliance 112 creates virtual disk(s) that collectively provide the file system.

At block 514, daemon appliance 112 boots the container VM. In an embodiment, at block 516, daemon appliance 112 adjusts CPU and/or memory allocations for the container VM. As discussed above, in block 504, the daemon appliance 112 can set a default CPU and memory allocation for the container VM during provisioning. However, a client application may request a larger CPU and/or memory allocation. The CPU and/or memory allocation can be adjusted prior to booting, or after booting if the guest OS of the container VM is of a type that allows “hot-adding” of CPU and/or memory resources (e.g., Linux®). At block 518, daemon appliance 112 attaches the file system to the container VM. In some examples, the container VM can boot from the attached file system. In other cases, the container VM can boot from a boot image generated at block 508. At block 520, daemon appliance 112 executes one or more bootstrapped processes. For example, daemon appliance 112 can execute a bootstrapped process in response to a request from a client application.

At block 516, daemon appliance 112 stops the container VM. At block 518, daemon appliance 112 can optionally create a new file system image. For example, a user may have modified the file system of the container VM. The modifications can be saved as a new file system image within the image hierarchy. At block 520, daemon appliance 112 deletes the container VM.

FIG. 6 is a flow diagram illustrating a lifecycle 600 of a container VM according to another embodiment. Container VM lifecycle 600 can be controlled by a daemon appliance 112. At block 602, daemon appliance 112 receives a request to provision a container VM from a client application. At block 604, daemon appliance 112 identifies a parent VM 226 from which the requested container VM can be created. At block 605, daemon appliance 112 creates a file system from file system image(s). In an embodiment, daemon appliance 112 creates virtual disk(s) that collectively provide the file system. At block 606, daemon appliance 112 forks a child VM from the parent VM to implement the container VM. At step 608, daemon appliance 112 stops the container VM. At optional step 610, daemon appliance 112 saves the state of the container VM to create a new parent VM. In such case, the container VM can be added to parent VMs 226 and can be used as a parent VM for another container to be created.

The forking process expedites the startup process of a container VM. The core of the guest OS is shared in memory with other container VMs. The startup time of a forked container VM is on the order of the startup time of a conventional container in a dedicated container host. With the forking process, in order to create a child VM, the runtime state of the parent VM must be frozen and remains so until it is deleted. Any number of child VMs can be formed from the parent VM and a new parent VM can be created from any other parent VM. In many respects, this parallels the notion of file system layering described above, except that instead of defining a layer of file-system state, it defines a layer of runtime state.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A computer system, comprising:
a plurality of host computers each executing a hypervisor;
a virtualization manager having an application programming interface (API) configured to manage the hypervisor on each of the plurality of host computers, the virtualization manager configured to create a virtual container host within a resource pool that spans the plurality of host computers;
a plurality of container virtual machines (VMs) in the virtual container host configured to consume resources in the resource pool; and
a daemon appliance executing in the virtual container host configured to invoke the API of the virtualization manager to manage the plurality of container VMs in response to commands from one or more clients.

2. The computer system of claim 1, wherein the virtualization manager is configured to schedule the plurality of container VMs across the plurality of host computers in response to requests from the daemon appliance.

3. The computer system of claim 1, wherein the daemon appliance is configured to schedule the plurality of container VMs across the plurality of host computers.

4. The computer system of claim 1, wherein the daemon appliance is configured to manage the plurality of container VMs by at least one of provisioning, booting, stopping, and deleting container VMs of the plurality of container VMs.

5. The computer system of claim 1, further comprising:
a parent container VM comprising a stopped virtual machine;
wherein the container VMs comprise child virtual machines forked from the stopped virtual machine of the parent container VM.

6. The computer system of claim 1, wherein each of the container VMs has a plurality of virtual disks attached thereto that provides a coherent file system.

7. The computer system of claim 6, wherein the daemon appliance is configured to create the virtual disks from file system images.

8. A computer system, comprising:
a hardware platform;
a hypervisor executing on the hardware platform, the hypervisor including an application programming interface (API);
a plurality of container VMs supported by the hypervisor; and
a daemon appliance configured to invoke the API of the hypervisor to manage the plurality of container VMs in response to commands from one or more clients.

9. The computer system of claim 8, wherein the daemon appliance is configured to manage the plurality of container VMs by at least one of provisioning, booting, stopping, and deleting container VMs of the plurality of container VMs.

10. The computer system of claim 8, further comprising:
a parent container VM comprising a stopped virtual machine;
wherein the container VMs comprise child virtual machines forked from the stopped virtual machine of the parent container VM.

11. The computer system of claim 10, wherein the daemon appliance is configured to fork the child virtual machines from the stopped virtual machine in response to container create requests from the one or more clients.

12. The computer system of claim 8, wherein each of the container VMs has a plurality of virtual disks attached thereto that provides a coherent file system.

13. The computer system of claim 12, wherein the daemon appliance is configured to create the virtual disks from file system images.

14. The computer system of claim 8, wherein each of the plurality of container VMs is allocated a default amount processor and memory resources of the hardware platform, and wherein the daemon appliance is configured to modify the amount of allocated processor and memory resources upon creation of the plurality of container VMs.

15. A method of managing container virtual machines (VMs) in a virtualized computing system, comprising:
creating a virtual container host within a resource pool that spans a plurality of host computers, the plurality host computers each executing a hypervisor managed through an application programming interface (API) of a virtualization manager;
creating a daemon appliance in the virtual container host configured to invoke the API of the virtualization manager;
creating a plurality of container VMs in the virtual container host configured to consume resources in the resource pool in response to commands from one or more clients received at the daemon appliance.

16. The method of claim 15, wherein the step of creating the plurality of container VMs comprises:
scheduling, by the virtualization manager, the plurality of container VMs across the plurality of host computers in response to requests from the daemon appliance.

17. The method of claim 15, wherein the step of creating the plurality of container VMs comprises:
scheduling, by the daemon appliance, the plurality of container VMs.

18. The method of claim 15, wherein the step of creating the plurality of container VMs comprises:
creating a parent container VM;
stopping the parent VM; and
forking child virtual machines from the parent VM to create the container VMs.

19. The method of claim 15, wherein each of the container VMs has a plurality of virtual disks attached thereto that provides a coherent file system.

20. The method of claim 15, further comprising:
creating the virtual disks from file system images.

21. A non-transitory computer readable medium comprising instructions, which when executed in a computer system, causes the computer system to carry out a method of managing container virtual machines (VMs) in a virtualized computing system, comprising:
creating a virtual container host within a resource pool that spans a plurality of host computers, the plurality host computers each executing a hypervisor managed through an application programming interface (API) of a virtualization manager;
creating a daemon appliance in the virtual container host configured to invoke the API of the virtualization manager;
creating a plurality of container VMs in the virtual container host configured to consume resources in the resource pool in response to commands from one or more clients received at the daemon appliance.
